(19) United States
(12) Patent Application Publication
(10) Pub. No.: US 2014/0313333 A1
(43) Pub. Date: Oct. 23, 2014

(54) SYSTEM AND METHOD FOR IMAGING A DRIVER OF A VEHICLE

(71) Applicant: FORD GLOBAL TECHNOLOGIES, LLC, Dearborn, MI (US)

(72) Inventors: Jialiang Le, Canton, MI (US); Manoharprasad K. Rao, Novi, MI (US); Kwaku O. Prakah-Asante, Commerce Township, MI (US)

(73) Assignee: Ford Global Technologies, LLC, Dearborn, MI (US)

(21) Appl. No.: 13/865,550

(22) Filed: Apr. 18, 2013

(51) Int. Cl. H04N 7/18

(52) U.S. Cl. CPC H04N 7/183
USPC 348/148

(57) ABSTRACT

A system and method for imaging a driver of a vehicle is provided. The system includes an imager mounted to a steering wheel hub that images a scene containing a bodily feature of the driver and generates image data therefrom. An image processor receives and analyzes the image data and generates biometric information related to the driver. The biometric information is useable as input for a variety of vehicle operations.

### FIELD OF THE INVENTION

The present invention generally relates to a vehicle imaging system and more specifically to an imaging system that generates biometric information relating to the driver.

### BACKGROUND OF THE INVENTION

Current imaging systems used in vehicles are typically adapted for a specific function. Therefore, there is a need for an imaging system with multi-functionality that is capable of being used in a variety of vehicle applications and operations.

### SUMMARY OF THE INVENTION

According to one aspect of the present invention, a vehicle imaging system is provided for imaging the driver of a vehicle. The vehicle imaging system includes an imager configured to image a scene containing a bodily feature of the driver and selectively enlarge or reduce the imaged scene and generate image data therefrom. The vehicle imaging system also includes an image processor configured to receive and analyze the image data to generate biometric information related to the driver that is useable as input for a vehicle operation.

According to another aspect of the present invention, a vehicle imaging system is provided for imaging the driver of a vehicle. The vehicle imaging system includes a camera mounted to a steering wheel hub and configured to image a scene containing a bodily feature of the driver and selectively enlarge or reduce the imaged scene and generate image data therefrom. The vehicle imaging system also includes an image processor configured to receive and analyze the image data to generate biometric information related to the driver that is useable as input for a vehicle operation.

According to another aspect of the present invention, a method for using a vehicle imaging system is provided. The method includes using an imager to image a scene containing a bodily feature of the driver and selectively perform one of an enlargement and reduction of the imaged scene and generate image data therefrom, receiving and analyzing the image data in an image processor to generate biometric information related to the driver, and outputting the biometric information to a vehicle system to assist with a vehicle operation.

These and other aspects, objects, and features of the present invention will be understood and appreciated by those skilled in the art upon studying the following specification, claims, and appended drawings.

### BRIEF DESCRIPTION OF THE DRAWINGS

In the drawings:

FIG. 1 is a front perspective view of a vehicle driver compartment where an imaging system having an imager according to an exemplary embodiment is shown mounted to a vehicle steering wheel hub;

FIG. 2 is a side perspective view of the vehicle driver compartment where the imager is imaging a scene containing a portion of the driver;

FIG. 3 is a block diagram of a vehicle imaging system that generates biometric information useable as input for a vehicle operation;

FIG. 4 is a flowchart of a zooming algorithm used by the imaging system to enlarge or reduce an imaged scene;

FIGS. 4A-4C is an image being enlarged according to the zooming algorithm;

FIGS. 5A-5B illustrate a tilted image that has been corrected using a vehicle steering angle;

FIGS. 5C-5D illustrate a tilted image that has been corrected using facial tracking;

FIG. 6 is a flowchart of processing data for a driver alertness monitoring system that utilizes one embodiment of the vehicle imaging system; and

FIG. 7 is a flowchart of processing data for an advanced restraint system that utilizes one embodiment of the vehicle imaging system.

### DETAILED DESCRIPTION OF THE PREFERRED EMBODIMENTS

As required, detailed embodiments of the present invention are disclosed herein. However, it is to be understood that the disclosed embodiments are merely exemplary of the invention that may be embodied in various and alternative forms. The figures are not necessarily to a detailed design and some schematics may be exaggerated or minimized to show function overview. Therefore, specific structural and functional details disclosed herein are not to be interpreted as limiting, but merely as a representative basis for teaching one skilled in the art to variously employ the present invention.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

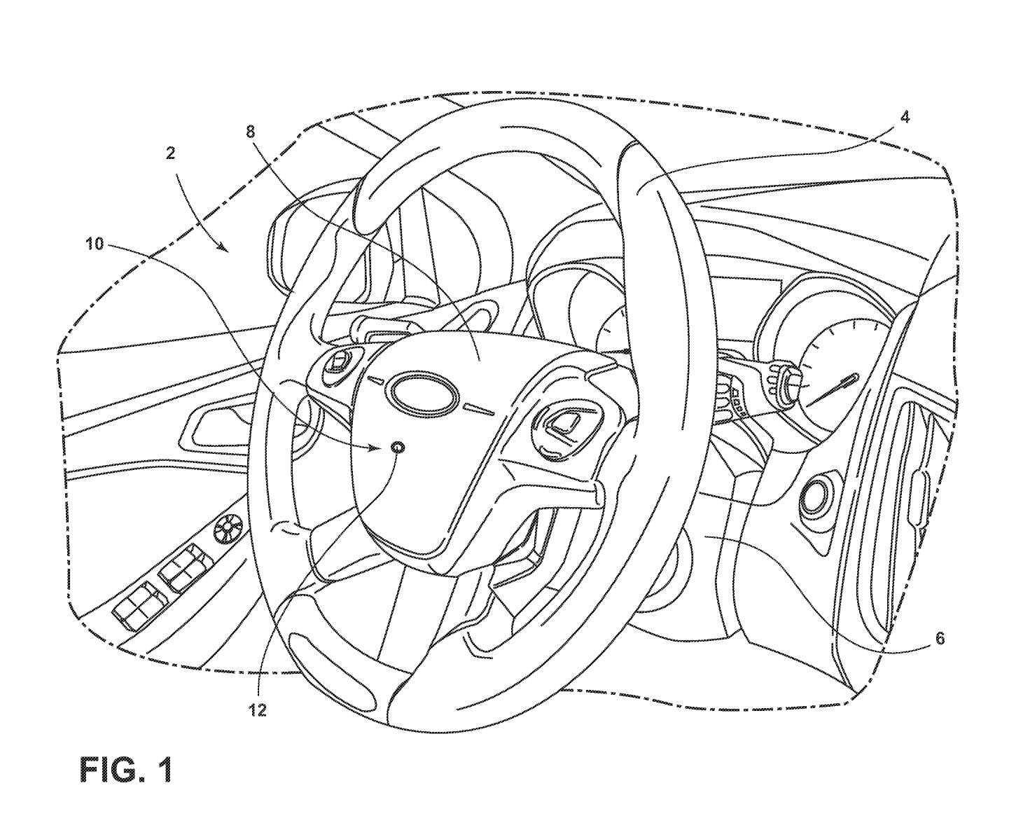

Referring to FIG. 1, a vehicle driver compartment 2 is generally shown having a steering wheel 4 mounted to a steering column 6 by a steering wheel hub 8. A system 10 for imaging a driver is provided inside the vehicle and includes an imager 12 mounted to the steering wheel hub 8 and configured to image a scene that includes at least a portion of the driver. To accomplish this, the imager 12 is typically pointed towards the driver and may include a camera positioned on the steering wheel hub 8 in a manner that does not interfere with other hub and wheel-mounted devices such as airbags and user interface controls. One method for mounting a camera to a steering wheel hub is described in U.S. Pat. No. 6,860,508 B2 to Keutz, filed on Oct. 3, 2002 and entitled “VEHICLE STEERING DEVICE,” the entire disclosure of which is incorporated herein by reference.

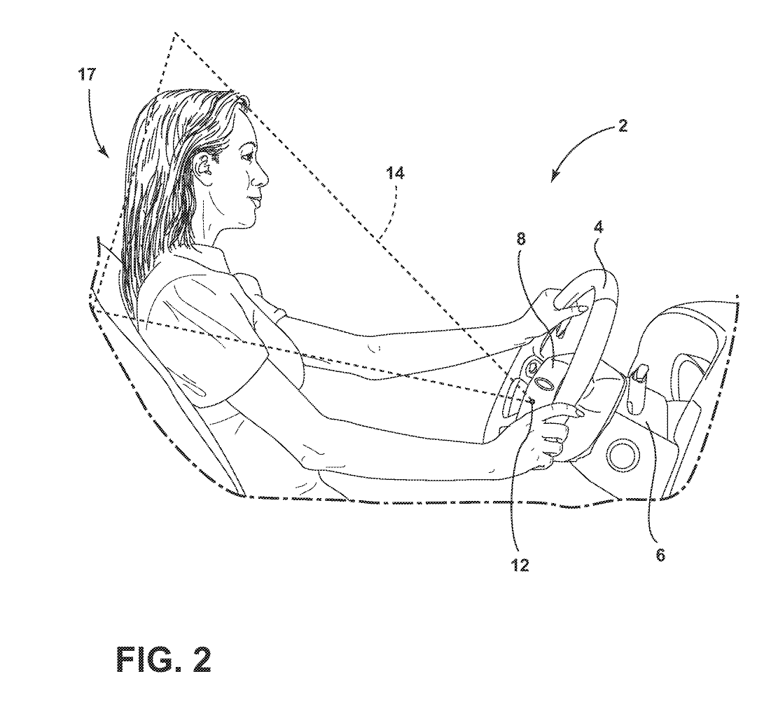

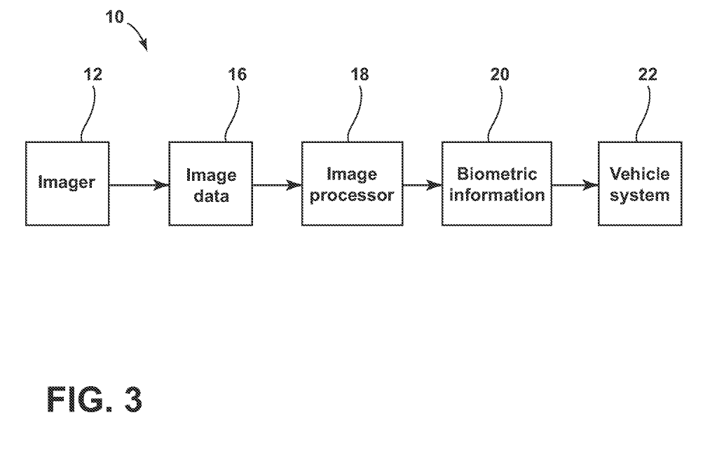

Referring to FIGS. 2 and 3, system 10 is exemplarily shown, wherein the imager 12 is mounted centrally on the steering wheel hub 8 and is configured to image a scene 14 and generate image data 16 therefrom. The scene 14 typically includes the area of the driver compartment 2 containing a bodily feature 17 of the driver and the image data 16 typically relates to characteristics of the bodily feature 17. The bodily feature 17 may include a general feature such as a driver's upper torso or a specific feature such as a driver's face and will typically depend on the particular task in which the system 10 operates.

As shown in FIG. 3, the image data 16 is received by an image processor 18 operably coupled to the imager 12 and configured to analyze the image data 16 to generate biometric information 20. The biometric information 20 typically includes characteristics associated with the driver being imaged and may be physiological and/or behavioral. Once generated, the biometric information 20 is outputted to one or more vehicle systems 22 charged with a vehicle operation. For example, the method for generating biometric information may be a subroutine executed by any processor, and thus, the method may be embodied in a non-transitory computer readable medium having stored thereon software instructions that, when executed by a processor, cause the processor to make the appropriate biometric determinations according to the specified operation.

One consequence of mounting the imager 12 to the steering wheel hub 8 is that the object of interest in scene 14 is typically located at some variable distance from the imager 12 due to factors such as driver seat and steering wheel positioning in addition to driver physique. At certain distances, the image data 16 may be susceptible to reduced image quality resulting in less precise driver monitoring for certain operations utilizing the system 10. To account for these types of scenarios, the imager 12 may include zooming capabilities configured to selectively enlarge or reduce the scene 14 to improve the accuracy of the associated image data 16.

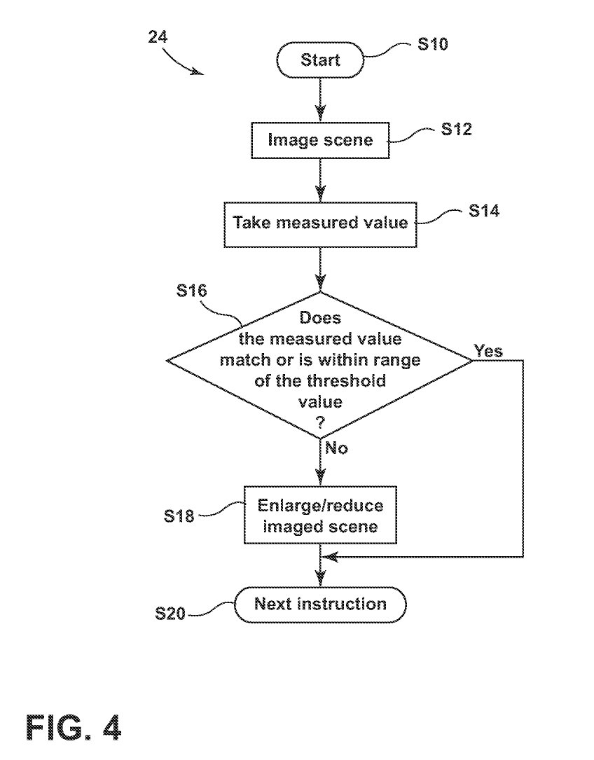

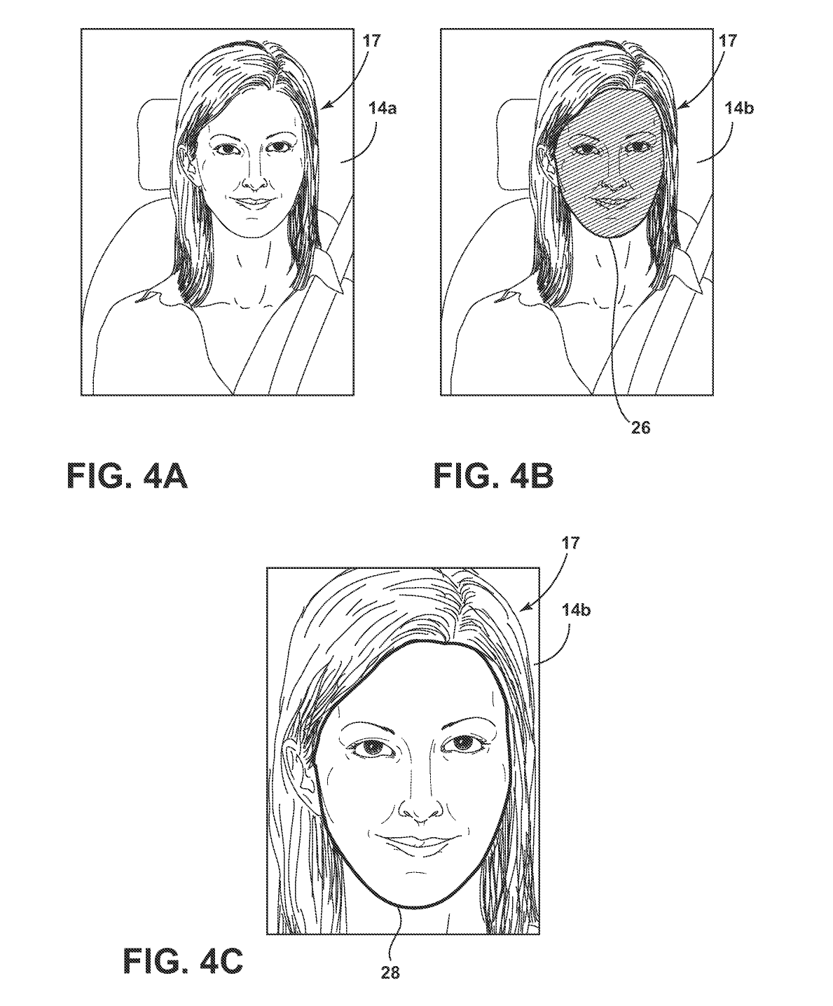

Referring to FIG. 4, a flowchart for one embodiment of a zooming algorithm 24 is shown and applied to a scene enlargement scenario illustrated in FIGS. 4A-4C having imaged scenes 14a, 14b, and 14c. To promote a better understanding, a facial tracking operation is described and the zooming algorithm 24 is exemplarily demonstrated from the vantage point of the imager 12 shown in FIG. 2. However, it is to be understood that the zooming algorithm 24 may also be used to enlarge scenes containing other specific and/or general features and may similarly be used for reducing the same. Furthermore, it is to be understood that the imager 12 shown in FIG. 2 may be used in a variety of operations, and as such, is not restricted to the scenario shown in FIGS. 4A-4C, which is described in detail below.

At the start of an imaging session, the imager 12 is initialized for the particular operation at step S10 and subsequently images a scene 14a containing the associated bodily feature 17 (i.e. the driver's face) in step S12 and shown in FIG. 4A. Scene 14a typically corresponds to the default image generated by the imager 12 when mounted to the steering wheel hub 8 prior to performing the zooming algorithm 24. As shown in scene 14a, facial outliers typically occupy the majority of the imaged scene 14a, which may unduly burden detail oriented operations such as facial tracking given the small image size of the face relative to the total size of scene 14a. This condition is remedied by first taking a measured value 26 relating to the pixel size of the face, as shown at step S14 and illustrated in scene 14b shown in FIG. 4B. Next, at step S16, the measured value 26 is compared to a threshold value 28, which may be a value stored in memory or generated during initialization (S10) or at some time thereafter. The threshold value 28 may define a single pixel size or range of pixel sizes, depending on operation. Typically, for facial tracking operations, optimization is better achieved by selecting a threshold value having a single pixel size that provides the most accurate image data. Alternatively, operations that are less detail oriented may opt for a threshold value having an acceptable range of pixel sizes.

If the measured value 26 matches or is within the range of the threshold value 28, the imager 12 does not perform the zooming algorithm 24 and proceeds to step S20, where the imager is instructed to either terminate the current imaging session, return to step S12 for continued imaging of the bodily feature 17, or return to step S10 to be initialized for a different operation.

In the event where the measured value 26 is less than or below the range of the threshold value 28, the imager 12 forms an enlarged scene 14c at step S18 such that the measured value 26 of the bodily feature 17 matches with or is within range of the threshold value 28, as illustrated in FIG. 4C. Alternatively, at step S18, the imager 12 forms a reduced scene (not shown) if the measured value 26 is greater than or above the range of the threshold value 28. In either event, once step S18 has completed, the imager 12 receives further instructions as previously described at step S20.

Another consequence of mounting the imager to the steering wheel hub arises when the steering wheel hub is rotatable with the steering wheel thereby causing the imager to rotate with the steering wheel hub when the driver rotates the steering wheel in either direction. As a result of this rotation, a tilt is applied to the imaged scene, which may hinder the ability of the processing unit to precisely analyze image data generated therefrom.

To avoid this issue, one solution is to use a non-rotatable steering wheel hub such as the one described in U.S. Pat. No. 7,390,018 B2 to Ridolfi et al., filed on Sep. 15, 2005 and entitled “STEERING WHEEL WITH NON-ROTATING AIRBAG,” the entire disclosure of which is incorporated herein by reference.

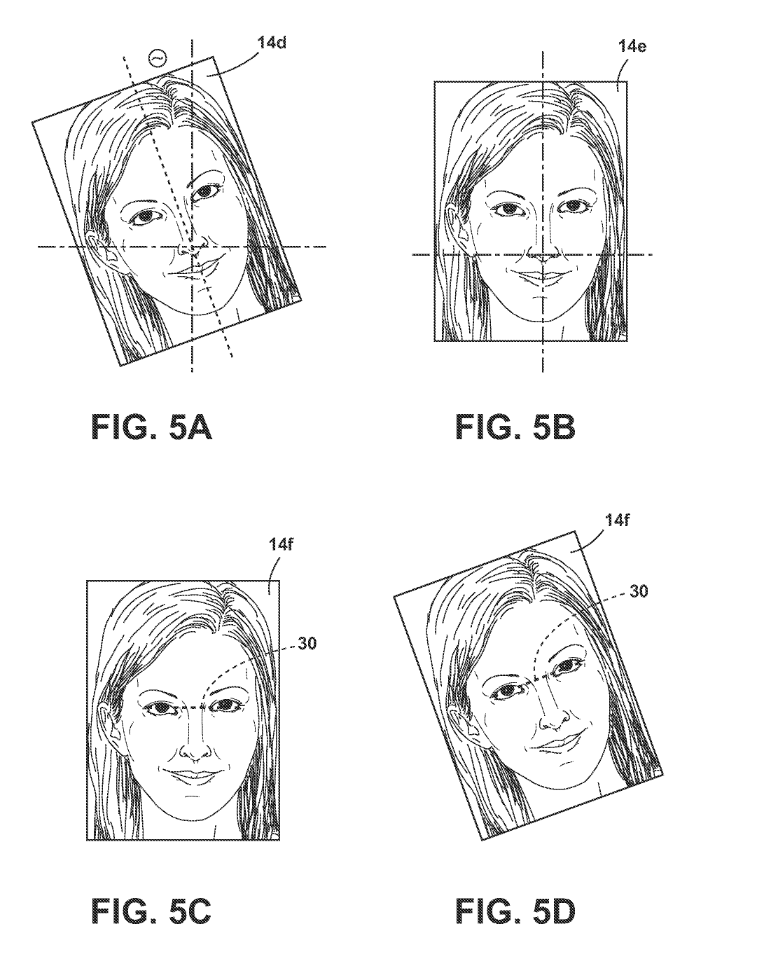

In instances where the steering wheel hub rotates with the steering wheel, a correction can be used to return the tilted image to an upright position. One exemplary procedure for correcting a tilted scene image is shown in FIGS. 5A and 5B. FIG. 5A illustrates an imaged scene 14d that is tilted at a variable angle θ, which typically corresponds to the angle of rotation of the steering wheel. To correct the tilt, the steering angle is obtained from a vehicle steering angle sensor and is received by the image processor and used to rotate the tilted scene 14d in the opposite direction to produce the corrected scene 14e shown in FIG. 5B.

An alternative procedure for correcting a tilted scene image is shown in FIGS. 5C and 5D. FIG. 5C illustrates an imaged scene 14f in a non-tilted position prior to rotation of the steering wheel. Using known facial tracking techniques such as edge analysis, the coordinates for the distal endpoints of the eyes are obtained and a connecting line 30 is drawn therebetween. A reference angle (not shown) is generated between the connecting line 30 and the horizon. When the imaged scene 14f tilts in one direction as a result of steering wheel rotation, the connecting line 30 makes a different angle relative to the horizon as shown in FIG. 5D. Correction ensues by rotating the imaged scene 14f in the opposite direction until the connecting line 30 once again makes the reference angle relative to the horizon, thereby returning the imaged scene 14f to its original upright position previously shown in FIG. 5A. With respect to the instant correction method, it should be recognized that other facial features and geometric relationships based thereon may be similarly used for accomplishing the same or similar tilt correction.

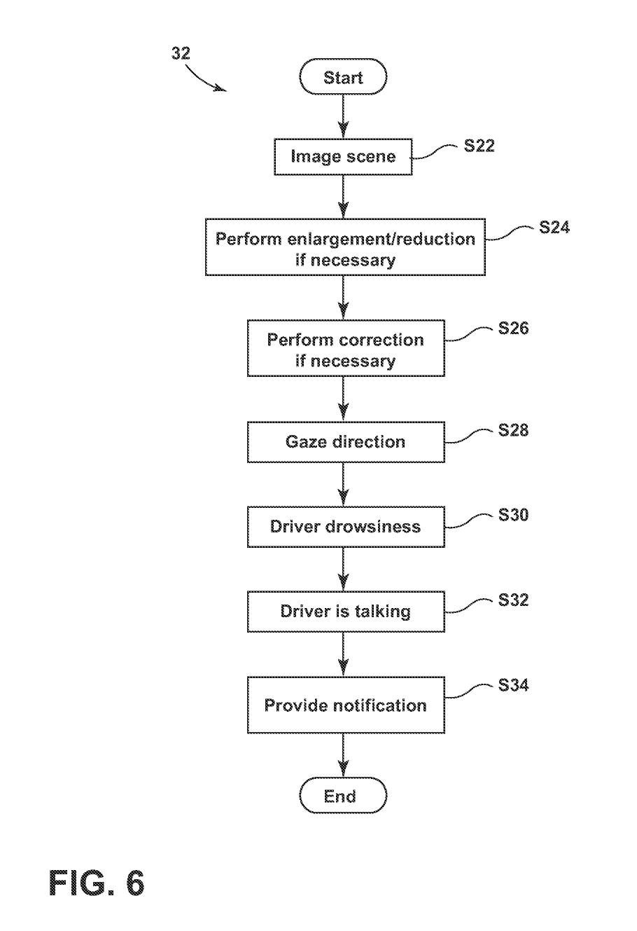

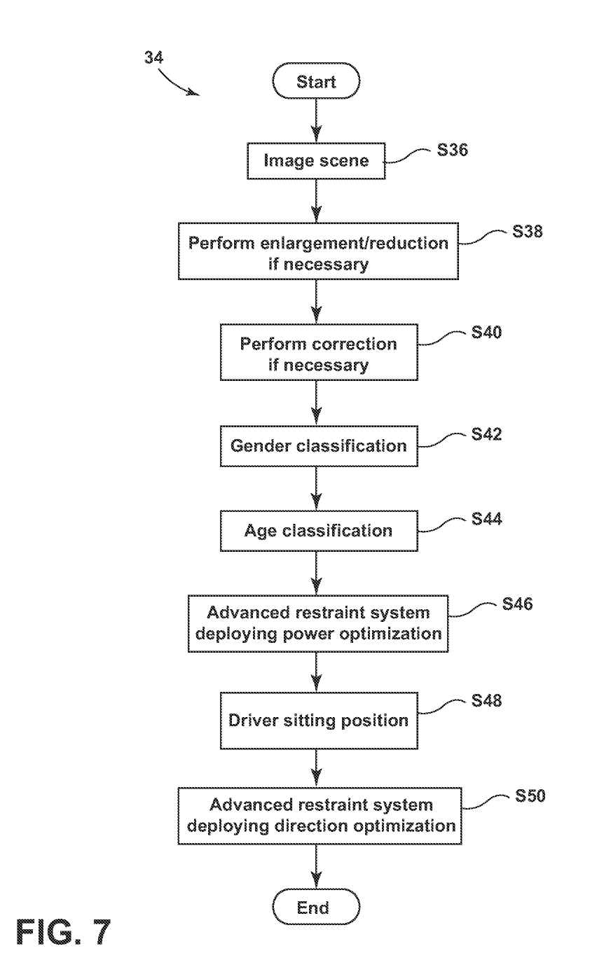

Referring to FIGS. 6 and 7, two flowcharts are shown, wherein each flowchart illustrates an exemplary operation performed by a vehicle system utilizing the system as described herein. However, it is to be understood that the system may be used in conjunction with other vehicle systems to perform other types of operations.

FIG. 6 is a flowchart for a driver alertness system 32 operating to monitor the attentiveness of a driver. At steps S22, S24, and S26, the scene is imaged and enlarged/reduced (if necessary) and corrected for tilt (if necessary). In the instant operation, a logical scene may include the driver's face and acquired image data relating thereto is sent to the image processor to be analyzed so that biometric information relating to driver alertness can be ascertained. For instance, at step S28, image data related to eye and/or head positioning is analyzed to determine the gaze direction of the driver. At step S30, image data related to the openness of the eyes is analyzed to determine driver drowsiness. At step S32, image data related to mouth position is analyzed to determine if the driver is talking. The biometric information generated in steps S28, S30, and S32 are taken singly or in combination to provide a notification to the driver in step S34 when the driver is in a state of inattentiveness. For example, if the driver is found to be drowsy in step S30, an auditory, tactile and/or visual notification can be sent to the driver via one or more vehicle systems such as the audio system, seat system and/or center display console, respectively. It should be noted that the biometric determinations found in steps S28, S30, and S32 are some possible biometric determinations related to driver attentiveness and it is acknowledged that others exist that are determinable using the system described herein. Also, it should be noted in each of those steps, zooming operations and/or tilt correction are free to occur as needed to increase the accuracy of the image data.

FIG. 7 is a flowchart for an advanced restraint system 34 operating to optimize airbag deployment in the event an accident occurs. At steps S36, S38, and S40, the scene image is enlarged/reduced (if necessary) and corrected for tilt (if necessary). At steps S42 and S44, image data relating to body size, facial shading, and/or facial features is analyzed to determine biometric information associated with the driver's gender and age. This biometric information may then be used by the advanced restraint system 34 to optimize deploying power of an airbag in step S46. For example, if the driver is an elderly individual with a small physique, a lessened and/or lower airbag deployment power could be used. At step 48, image data relating to the driver's body size and/or orientation is analyzed to determine biometric information associated with the driver's sitting position. This biometric information may then be used by the advanced restraint system 34 at step S50 to optimize the direction of airbag deployment. For example, if the driver is tall, then the direction of airbag deployment will be more upwardly relative to a shorter person.

As should be readily apparent, these are just two of many possible operations benefitting from the use of the system described herein and those having ordinary skill in the art will readily appreciate the versatility and applicability of the system to a wide range of vehicle operations.

Accordingly, a system for imaging a driver of a vehicle has been advantageously described herein. The system is multi-functional and generates biometric information related to the driver that is usable as input for a variety of vehicle operations.

It is to be understood that variations and modifications can be made on the aforementioned structure without departing from the concepts of the present invention, and further it is to be understood that such concepts are intended to be covered by the following claims unless these claims by their language expressly state otherwise.

What is claimed is:

1. A vehicle imaging system, comprising:
an imager configured to image a scene containing a bodily feature of a driver and selectively perform one of an enlargement and reduction of the imaged scene and generate image data therefrom; and
an image processor configured to receive and analyze the image data to generate biometric information related to the driver that is outputted to a vehicle system to assist the vehicle system in performing a vehicle operation.

2. The vehicle imaging system of claim 1, wherein the imager is mounted on a non-rotating vehicle steering wheel hub.

3. The vehicle imaging system of claim 2, wherein the imager is mounted on a rotating vehicle steering wheel hub and the image processor is further configured to provide a correction of a tilted image that is caused by the driver turning the steering wheel, wherein the correction returns the tilted image to an upright position.

4. The vehicle imaging system of claim 1, wherein the imager comprises a camera with the capability for zooming, and is configured to enlarge the image scene if the bodily feature is less than a threshold value and reduce the imaged scene if the pixel size is greater than the threshold value, wherein the threshold value comprises at least one of a single pixel value and range of pixel values.

5. The vehicle imaging system of claim 1, wherein the image data relates to at least one characteristic of the bodily feature.

6. The vehicle imaging system claim 1, wherein the biometric information relates to at least one of a behavioral characteristic and a physiological characteristic of the driver.

7. The vehicle imaging system of claim 1, wherein the vehicle system comprises an advanced restraint system operating to optimize deployment of an airbag in the event of an accident and the biometric information is used to determine at least one of a deploying power and a deploying direction of an airbag located in the driver compartment.

8. The vehicle imaging system of claim 1, wherein the vehicle operation comprises a driver alertness system operating to monitor the attentiveness of the driver and the biometric information is used to provide a notification to the driver when the driver is in a state of inattentiveness.

9. A vehicle imaging system, comprising:
a camera mounted to a steering wheel hub and configured to image a scene containing a bodily feature of a driver and selectively perform one of an enlargement and reduction of the imaged scene and generate image data therefrom; and
an image processor configured to receive and analyze the image data to generate biometric information related to the driver that is outputted to a vehicle system performing a vehicle operation.

10. The vehicle imaging system of claim 9, wherein the steering wheel hub comprises a non-rotating vehicle steering wheel hub.

11. The vehicle imaging system of claim 9, wherein the steering wheel hub comprises a rotating vehicle steering wheel hub and the image processor is further configured to provide a correction of a tilted image that is caused by rotation of the steering wheel, wherein the correction returns the tilted image to an upright position.

12. The vehicle imaging system of claim 9, wherein the camera is configured to enlarge the imaged scene if the bodily feature has a pixel size that is less than a threshold value and reduce the imaged scene if the bodily feature has a pixel size greater than the threshold value, wherein the threshold value comprises at least one of a single pixel value and range of pixel values.

13. The vehicle imaging system claim 9, wherein the image data relates to at least one characteristic of the bodily feature and the biometric information relates to at least one of a behavioral characteristic and a physiological characteristic of the bodily feature.

14. The vehicle imaging system of claim 9, wherein the vehicle system comprises an advanced restraint system operating to optimize airbag deployment in the event an accident occurs and the biometric information is used to determine at least one of a deploying power and a deploying direction of an airbag located in the driver compartment.

15. The vehicle imaging system of claim 9, wherein the vehicle system comprises a driver alertness system operating to monitor the attentiveness of the driver and the biometric information is used to provide a notification to the driver when the driver is in a state of inattentiveness.

16. A method for using a vehicle imaging system, comprising:
using an imager to image a scene containing a bodily feature of the driver and selectively perform one of an enlargement and reduction of the imaged scene and generate image data therefrom;
receiving and analyzing the image data in an image processor to generate biometric information related to the driver; and
outputting the biometric information to a vehicle system to assist with a vehicle operation.

17. The method of claim 16, further comprising providing the imager on a vehicle steering wheel hub.

18. The method of claim 16, further comprising using a zooming algorithm to selectively perform one of the enlargement and reduction of the imaged scene, wherein the zooming algorithm enlarges the imaged scene if the bodily feature has a pixel size that is less than a threshold value and reduces the imaged scene if the bodily feature has a pixel size greater than the threshold value, wherein the threshold value comprises at least one of a single pixel value and range of pixel values.

19. The method of claim 16, wherein the vehicle system comprises an advanced restraint system operating to optimize airbag deployment in the event an accident occurs and the biometric information is used to determine at least one of a deploying power and a deploying direction of an airbag located in the driver compartment.

20. The method of claim 16, wherein the vehicle system comprises a driver alertness system operating to monitor the attentiveness of the driver and the biometric information is used to provide a notification to the driver when the driver is in a state of inattentiveness.
